(19) United States
(12) Patent Application Publication
(10) Pub. No.: US 2002/0087765 A1
(43) Pub. Date: Jul. 4, 2002

(54) Method and system for completing purge requests or the like in a multi-node multiprocessor system

(76) Inventors: Akhilesh Kumar, Sunnyvale, CA (US); Manoj Khare, Saratoga, CA (US); Lily P. Looi, Portland, OR (US)

Correspondence Address: Kenyon & Kenyon, Suite 600, 333 W. San Carlos Street, San Jose, CA, 95110-2711, US

(21) Appl. No.: 09/752,869

(22) Filed: Dec. 29, 2000

(51) Int. Cl. G06F 13/00

(52) U.S. Cl. 710/107

(57) ABSTRACT

In a multi-node system, a method and apparatus to implement a request such as a purge TLB entry request is described. In one embodiment, a processor initiates a purge TLB request and any other processors assert a signal in response (pending completion of the request). A node controller coupled to the processor via a bus asserts the same signal to indicate that the request has not been completed. The node controller can then send the request to other node controller (potentially via a switching agent), so that other processors in the multi-node system can complete the request. Once all processors in the other nodes have completed the request, the node controller can deassert the signal, which indicates to the requesting processor that the request has been completed at all processor outside of its node.

### BACKGROUND OF THE INVENTION

The present invention pertains to completing TLB purge requests in a multi-node, multiprocessor system. More particularly, the present invention pertains to the purging of entries in a translation lookaside buffer in a multi-node multiprocessor system.

In known processor systems, a translation lookaside buffer (TLB) cache memory is provided to assist in address translation from a logical (or virtual) address to a physical address. For example, in the Pentium and Itanium processors manufactured by Intel Corporation (Santa Clara, Calif.), a TLB is provided that stores a number of “page table entries.” In one example, each page table entry includes a virtual page number and a page frame number. To generate a physical address, one starts with a virtual address that includes a virtual page number and an offset. The TLB entries are searched to locate one that has a virtual page number that matches the virtual page number of the virtual address. The corresponding page frame number of the matched page table entry is then combined with the offset to create the physical address. If there is no match (referred to as a TLB miss), then potentially a supplemental memory is checked (e.g., a Page Table memory) to try and locate the matching page table entry. If it is found, then the TLB replaces one of its entries with the matching page table entry. If there is a miss in the Page Table memory, then the reference page must be located in a tertiary memory (e.g., a hard-disk drive). Because TLB misses result in delay in instruction execution, it is important that the TLB contain the page number and page frame number pairs that are most likely to be needed by the processor.

As stated above, unneeded TLB entries are written over or purged in the processor to keep the TLB up-to-date. In many multiprocessor systems, two or more processors are coupled together via a common bus. It may be desirable for one processor to not only purge a TLB entry of its own, but have the same entry purged in the other processors in the system. To achieve this, a processor will send out a purge TLB entry request to the other processors on the bus. In response, the processors receiving the request assert an output signal (e.g. TND# in the Itanium™ processor, where # indicates a negative assertion). These output signals from all the processors on the bus are connected together in a wired-OR manner such that assertion of this signal from one or multiple agents on the bus can be detected by the requesting processor. As each processor completes the task, the TND# signal is deasserted. Once all of the processors have deasserted these signals, the requesting processor knows that the purge TLB entry request has been completed by all the processors on the bus.

Completing a purge table entry request in a multi-node, multiprocessor system cannot be done in the same manner because there is no common bus in such a system. Accordingly, there is a need for a method and system that provides for a purge TLB entry or similar request in a multi-node, multiprocessor system.

### BRIEF DESCRIPTION OF THE DRAWINGS

FIG. 1 is a block diagram of a multiprocessor system operated according to an embodiment of the present invention.

FIGS. 2a-b are flow diagrams of a method for implementing a bus lock according to an embodiment of the present invention.

### DETAILED DESCRIPTION

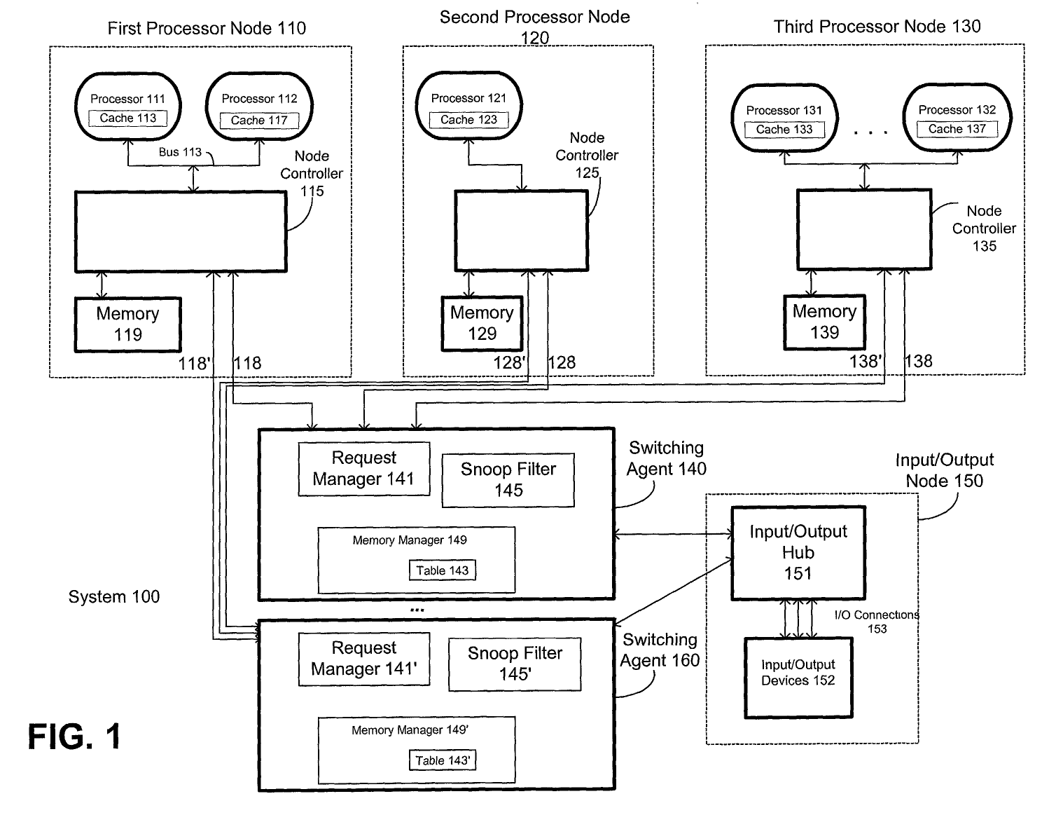

Referring to FIG. 1, a block diagram of a multiprocessor system operated according to an embodiment of the present invention is shown. In FIG. 1 a system having multiple nodes that share memory devices, input/output devices and other system resources is shown. A system 100 is a computer system that includes processors, memory devices, and input/output devices. Components in system 100 are arranged into architectural units that are referred to herein as nodes. Each node may contain one or more processors, memories, or input/output devices. In addition, the components within a node may be connected to other components in that node through one or more busses or lines. Each node in system 100 has a node connection that may be used by the components within that node to communicate with components in other nodes. In one embodiment, the node connection for a particular node is used for any communication from a component within that node to another node. In system 100, the node connection for each node is connected to a switching agent 140. A system that has multiple nodes is referred to as a multi-node system. A multi-node system for which each node communicates to other nodes through a dedicated connection may be said to have a point-to-point architecture.

The nodes in system 100 may cache data for the same memory block for one of the memories in the system. For example, a cache in each node in the system may contain a data element corresponding to a block of a system memory (e.g., a RAM memory that is located in one of the nodes). If a first node decides to modify its copy of this memory block, it may invalidate the copies of that block that are in other nodes (i.e., invalidate the cache lines) by sending an invalidate message to the other nodes. If the first node attempts to invalidate a cache line in the other nodes, and the second node has already modified that cache line, then the first node may read the new cache line from the second node before invalidating the cache line in the second node. In this way, the first node may obtain the updated data for that cache line from the first node before the first node operates on that data. After obtaining the updated data, the first node may invalidate the cache line in the second node. To accomplish this, the first node may send a read and invalidate request to the second node.

The details shown in FIG. 1 will now be discussed. As shown in FIG. 1, system 100 includes a first processor node 110, a second processor node 120, a third processor node 130, and an input/output node 150. Each of these nodes is coupled to switching agent 140. The term “coupled” encompasses a direct connection, an indirect connection, an indirect communication, etc. First processor node 110 is coupled to switching agent 140 through external connection 118, second processor node 120 is coupled to switching agent 140 through external connection 128, and third processor node 130 is coupled to switching agent 140 through external connection 138.

First processor node 110 includes processor 111, processor 112, and node controller 115, which are coupled to each other by bus 113. Processor 11 1 and processor 1 12 may be any microprocessors that are capable of processing instructions, such as for example a processor in the Intel Itanium family of processors. Bus 113 may be a shared bus. First processor node 110 also contains a memory 119 which is coupled to node controller 115. Memory 119 may be a Random Access Memory (RAM). Processor 111 may contain a cache 113, and processor 112 may contain a cache 117. Cache 113 and cache 117 may be Level 2 (L2) cache memories that are comprised of static random access memory.

Similarly, second processor node 120 contains a processor 121 and node controller 125 which are coupled to each other. Second processor node 120 also contains a memory 129 that is coupled to node controller 125. Third processor node 130 contains a processor 131, processor 132, and node controller 135 that are coupled to each other. Third processor node 130 also contains a memory 139 that is coupled to node controller 135. Processor 121 may contain a cache 123, processor 131 may contain a cache 133, and processor 132 may contain a cache 137. Processors 121, 131, and 132 may be similar to processors 111 and 112. In an embodiment, two or more of processors 111, 112, 121, 131, and 132 are capable of processing a program-in parallel. Node controllers 125 and 135 may be similar to node controller 115, and memory 129 and 139 may be similar to memory 119. As shown in FIG. 1, third processor node 130 may contain processors in addition to 131 and 132. Similarly, first processor node 110 and second processor node 120 may also contain additional processors.

In one embodiment, switching agent 140 may be a routing switch for routing messages within system 100. As shown in FIG. 1, switching agent 140 may include a request manager 141, which may include a processor, for receiving requests from the processor nodes 110, 120, and 130. In this embodiment, request manager 141 includes a snoop filter 145. A memory manager 149, which may include a table 143 or other such device, may be provided to store information concerning the status of the processor nodes as described below. Switching agent 160, likewise includes a request manager 141′, a memory manager 149′ and table 143′ along with snoop filter 145′. Though two switching agents 140, 160 are shown in FIG. 1, additional switching agents may be provided.

As shown in FIG. 1, input/output node 150 contains an input/output hub 151 that is coupled to one or more input/output devices 152 via I/O connections 153. Input/output devices 152 may be, for example, any combination of one or more of a disk, network, printer, keyboard, mouse, graphics display monitor, or any other input/output device. Input/output hub 151 may be an integrated circuit that contains bus interface logic for interfacing with a bus that complies to the Peripheral Component Interconnect standard (version 2.2, PCI Special Interest Group) or the like. Input/output devices 152 may be similar to, for example, the INTEL 82801AA I/O Controller Hub. Though one I/O Node is shown, two or more I/O Nodes may be coupled to the switching agents.

In an embodiment, node controller 115, switching agent 140, and input/output hub 151 may be a chipset that provides the core functionality of a motherboard, such as a modified version of a chipset in the INTEL 840 family of chipsets.

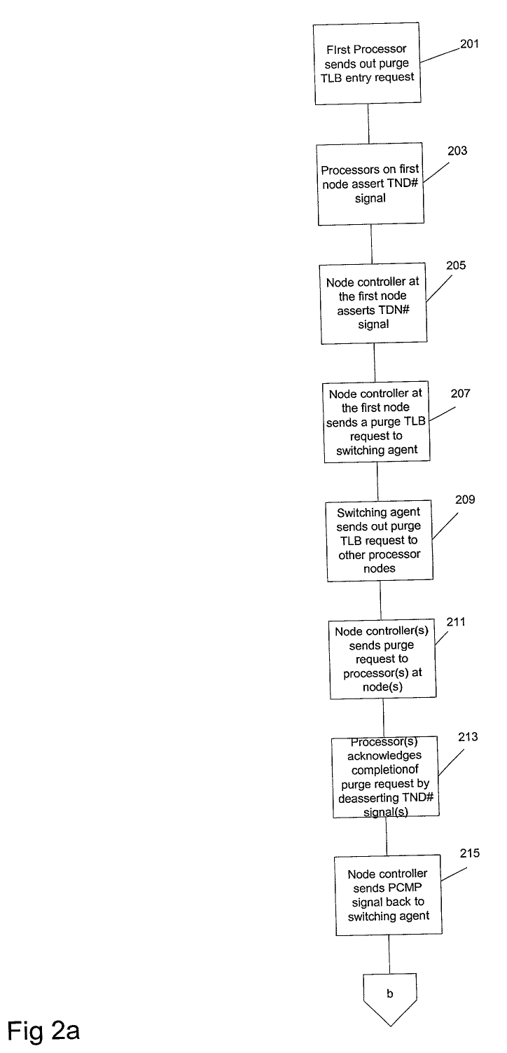

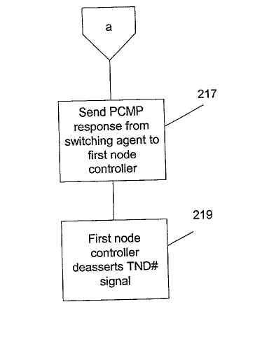

Referring to FIGS. 2a-b, a flow diagram of a method for implementing a purge TLB entry request according to an embodiment of the present invention is shown. In block 201, a first processor (e.g., processor 111) initiates a purge TLB entry request at the first processor node 110. The purge TLB entry will include the virtual page number, a region identifier, etc. In response to that request, one or more processors at the first processor node will assert its TND# signal (block 203) indicating that the processor is beginning the processing of the purge TLB entry request. In block 205, the node controller 115 asserts a TND# signal as well. As will be seen below, the node controller is asserting TND# to represent that all other nodes are beginning, but have not completed, the purge TLB entry request. In block 207, the node controller sends a purge TLB entry request to the switching agent 140 (e.g., PPTC in this embodiment). In block 209, the switching agent 140 sends the PPTC request to the other processor nodes in the system (e.g., node controllers 125 and 135).

In block 211, the node controller sends a purge TLB entry request on the bus for all the processor at its node. The processors at these nodes will acknowledge the request by asserting the TND# signal (block 213). The node controller watches the TND# signals, waiting for it to be deasserted (indicating that the appropriate page table entry has been purged from the TLB in all the processors on the bus). When the TND# signals have been deasserted, control passes to block 215, where the node controller sends a completion signal (e.g., a PCMP response in this embodiment) to the switching agent 140. In block 217 (FIG. 2b), the switching node receives the PCMP signals from each of the non-requesting processor nodes and sends a PCMP signal to node controller 115 indicating that all processors in all other nodes have completed the purge request. In block 219, the node controller deasserts its TND# signal indicating to the requesting processor that all processors in the other nodes have performed the requested purge function. Accordingly, when all other processors have also deasserted their respective TND# signals, the requesting processor knows that the purge TLB entry request has been completed at all processors in the multi-node system.

The current system can also be used to perform locked-bus operation (i.e., an operation where one processor completes successive transactions on the buses in the nodes before another processor can perform a transaction on the same buses). Thus, a first node controller may issues a lock request on behalf of a processor. This may result in the receiving node controller making sure all of its requests are completed before locking its associated bus. As described above, a node controller may send a purge TLB entry request to the other node. The receiving node may wait for all of its memory transactions to be completed before doing the purge transaction. The interaction of lock requests and purge TLB entry requests may result in a deadlock situation in the system because of the following:

1. The node controller that sent out the lock request has locked its bus, preventing completion of the purge TLB entry request; and

2. The node controller that sent out the purge TLB entry request may seek to complete that transaction before locking its own bus.

There are at least two ways to correct this, one is to make sure that operating systems that allow purge TLB entry requests, disable bus lock requests. Alternatively, the system may be modified to allow both requests to exist at the same time, but they must do so without blocking each other. One way to achieve this is to ignore the purge TLB entry request when a locked-bus request is being processed.

In this embodiment, the purge TLB request is only sent to processor nodes in the system. If there are other nodes that do not contain processors, e.g. I/O node 150, the PPTC request is not sent to those nodes.

Although several embodiments are specifically illustrated and described herein, it will be appreciated that modifications and variations of the present invention are covered by the above teachings and within the purview of the appended claims without departing from the spirit and intended scope of the invention. For example, the system and method of the present invention may be applied to other requests that include an acknowledgement signal from other processors when the requested task is completed.

What is claimed is:

1. A multi-node system comprising:
a first node including a first processor and a first node controller, where said first processor is to generate a request and said first node controller is to assert a signal to said first processor to indicate that processing of said request is incomplete.

2. The multi-node system of claim 1 further comprising:
a second node controller coupled to said first node controller to receive said request.

3. The multi-node system of claim 2 wherein said second node controller is part of a second node including a second processor coupled to said second node controller, wherein said second processor is to complete said request.

4. The multi-node system of claim 2 further comprising:
a switching agent coupled between said first and second node controllers.

5. The multi-node system of claim 4, wherein said second processor is to complete said request.

6. The multi-node system of claim 3, where said first node controller is to deassert said signal when said request is completed at said second node.

7. The multi-node system of claim 5, where said first node controller is to deassert said signal when said request is completed at said second node.

8. The multi-node system of claim 1 wherein said request is a purge TLB entry request.

9. The multi-node system of claim 6 wherein said request is a purge TLB entry request.

10. The multi-node system of claim 7 wherein said request is a purge TLB entry request.

11. A method for processing a request in a multi-node system comprising:
sending a request from a first processor to a first node controller;
asserting a signal from said first node controller to said first processor indicating that processing of said request is incomplete.

12. The method of claim 11 further comprising:
sending said request to a second node controller in said multi-node system.

13. The method of claim 12 further comprising:
completing said request for at least one processor coupled to said second node controller.

14. The method of claim 13 further comprising:
deasserting said signal by said first node controller when said request is completed at said second node.

15. The method of claim 11 wherein said request is a purge TLB entry request.

16. The method of claim 14 wherein said request is a purge TLB entry request.

17. A method for processing a request in a multi-node system comprising:
sending a request from a first processor to a first node controller;
asserting a signal from said first node controller to said first processor indicating that processing of said request is incomplete; and
sending said request to a second node controller via a switching agent in said multi-node system.

18. The method of claim 17 further comprising:
completing said request for at least one processor coupled to said second node controller.

19. The method of claim 18 further comprising:
deasserting said signal by said first node controller when said request is completed at said second node.

20. The method of claim 17 wherein said request is a purge TLB entry request.

21. The method of claim 18 where in said request is a purge TLB entry request.
